(19) United States
(12) Patent Application Publication
(10) Pub. No.: US 2014/0092006 A1
(43) Pub. Date: Apr. 3, 2014

(54) DEVICE AND METHOD FOR MODIFYING RENDERING BASED ON VIEWER FOCUS AREA FROM EYE TRACKING

(71) Applicants: Joshua Boelter, Portland, OR (US); Don G. Meyers, Rescue, CA (US); David Stanasolovich, Albuquerque, NM (US); Sudip S. Chahal, Gold River, CA (US)

(72) Inventors: Joshua Boelter, Portland, OR (US); Don G. Meyers, Rescue, CA (US); David Stanasolovich, Albuquerque, NM (US); Sudip S. Chahal, Gold River, CA (US)

(21) Appl. No.: 13/631,476

(22) Filed: Sep. 28, 2012

(51) Int. Cl. G06F 3/01

(52) U.S. Cl. 345/156

(57) ABSTRACT

Devices and methods for modifying content rendered on the display of a computing device as a function of eye focus area include receiving sensor data from one or more eye tracking sensors, determining an eye focus area on the display screen as a function of the sensor data, and adjusting one or more visual characteristics of the rendered content as a function of the eye focus area. Perceived quality of the rendered content may be improved by improving the visual characteristics of the content displayed within the eye focus area. Rendering efficiency may be improved by degrading the visual characteristics of the content displayed outside of the eye focus area. Adjustable visual characteristics include the level of detail used to render the content, the color saturation or brightness of the content, and rendering effects such as anti-aliasing, shading, anisotropic filtering, focusing, blurring, lighting, and/or shadowing.

### BACKGROUND

Users and developers generally demand ongoing increases in the quality of content rendered on computing devices. For example, video gaming tends to demand increased realism and quality in rendered content to create an immersive, compelling gaming experience. Traditional computing devices render content with the expectation that the user may focus his or her gaze on any part of the display screen of the computing device at any particular time. To realize improvements in rendering quality, traditional computing devices generally rely on increasing the amount of hardware resources available for rendering (e.g., by increasing the number of silicon logic gates, the clock frequency, available bus bandwidth, or the like).

Eye-tracking sensors track the movement of a user's eyes and thereby calculate the direction of the user's gaze while using the computing device. Eye-tracking sensors allow the computing device to determine on what part or parts of the display screen the user is focusing his or her gaze. Already common in research settings, eye-tracking technology will likely become less expensive and more widely adopted in the future.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 is a simplified block diagram of at least one embodiment of a computing device to modify rendered content on a display based on a viewer focus area;

FIG. 2 is a simplified block diagram of at least one embodiment of an environment of the computing device of FIG. 1;

FIG. 3 is a simplified flow diagram of at least one embodiment of a method for modifying rendered content on the display based on the viewer focus area, which may be executed by the computing device of FIGS. 1 and 2; and

FIG. 4 is a schematic diagram representing a viewer focusing on an area on the display of the computing device of FIGS. 1 and 2.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present disclosure. It will be appreciated, however, by one skilled in the art that embodiments of the disclosure may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Embodiments of the invention may be implemented in hardware, firmware, software, or any combination thereof. Embodiments of the invention implemented in a computer system may include one or more bus-based interconnects between components and/or one or more point-to-point interconnects between components. Embodiments of the invention may also be implemented as instructions carried by or stored on a transitory or non-transitory machine-readable (e.g., computer-readable) medium, which may be read and executed by one or more processors. A machine-readable medium may be embodied as any device, mechanism, or physical structure for storing or transmitting information in a form readable by a machine (e.g., a computing device). For example, a machine-readable medium may be embodied as read only memory (ROM); random access memory (RAM); magnetic disk storage media; optical storage media; flash memory devices; mini- or micro-SD cards, memory sticks, electrical signals, and others.

In the drawings, specific arrangements or orderings of schematic elements, such as those representing devices, modules, instruction blocks and data elements, may be shown for ease of description. However, it should be understood by those skilled in the art that the specific ordering or arrangement of the schematic elements in the drawings is not meant to imply that a particular order or sequence of processing, or separation of processes, is required. Further, the inclusion of a schematic element in a drawing is not meant to imply that such element is required in all embodiments or that the features represented by such element may not be included in or combined with other elements in some embodiments.

In general, schematic elements used to represent instruction blocks may be implemented using any suitable form of machine-readable instruction, such as software or firmware applications, programs, functions, modules, routines, processes, procedures, plug-ins, applets, widgets, code fragments and/or others, and that each such instruction may be implemented using any suitable programming language, library, application programming interface (API), and/or other software development tools. For example, some embodiments may be implemented using Java, C++, and/or other programming languages. Similarly, schematic elements used to represent data or information may be implemented using any suitable electronic arrangement or structure, such as a register, data store, table, record, array, index, hash, map, tree, list, graph, file (of any file type), folder, directory, database, and/or others.

Further, in the drawings, where connecting elements, such as solid or dashed lines or arrows, are used to illustrate a connection, relationship or association between or among two or more other schematic elements, the absence of any such connecting elements is not meant to imply that no connection, relationship or association can exist. In other words, some connections, relationships or associations between elements may not be shown in the drawings so as not to obscure the disclosure. In addition, for ease of illustration, a single connecting element may be used to represent multiple connections, relationships or associations between elements. For example, where a connecting element represents a communication of signals, data or instructions, it should be understood by those skilled in the art that such element may represent one or multiple signal paths (e.g., a bus), as may be needed, to effect the communication.

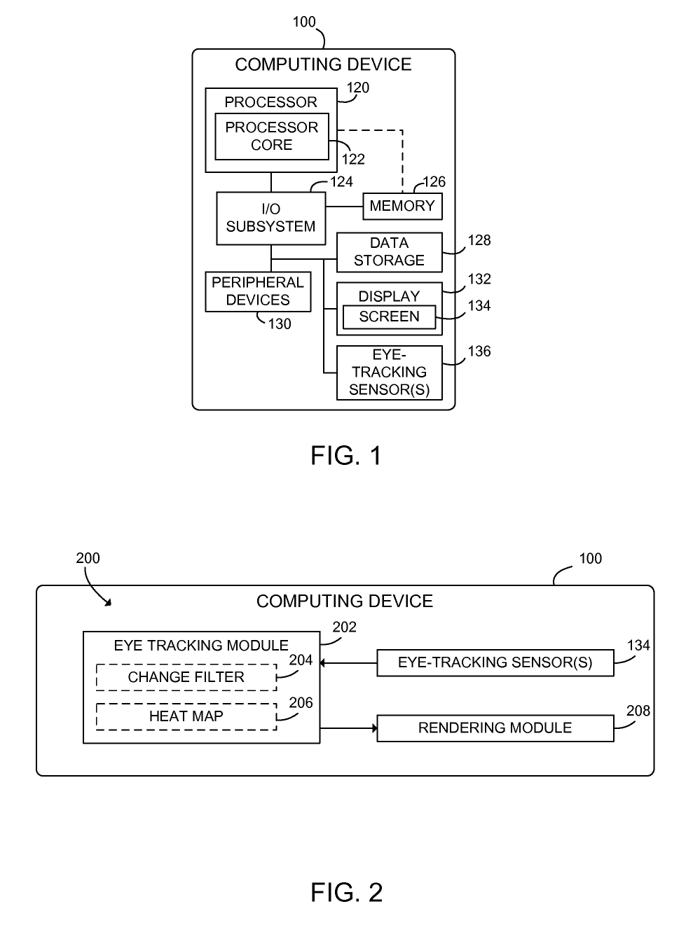

Referring now to FIG. 1, in one embodiment, a computing device 100 is configured to modify content on a display of the computing device 100 as a function of a viewer's eye focus area. To do so, as discussed in more detail below, the computing device 100 is configured to utilize one or more eye tracking sensors to determine the viewer's eye focus area. The computing device 100 responsively, or continually, adjusts one or more visual characteristics of the rendered content within and/or outside of the eye focus area.

Modifying the rendered content as a function of the eye focus area may provide cost, bandwidth, and/or power savings over traditional rendering techniques. For example, in some embodiments, by prioritizing rendering within the viewer's eye focus area, the computing device 100 may render content that is perceived by the viewer to be of higher quality than typical rendering, using the same hardware resources (e.g., the same number of silicon logic gates). Alternatively, in other embodiments the computing device 100 may use fewer hardware resources or require less bandwidth to render content perceived by the viewer to be of equivalent quality to typical rendering. It should be appreciated that the reduction of hardware resources may reduce the cost of the computing device 100. Also, reducing hardware resources and using existing hardware resources more efficiently may reduce the power consumption of the computing device 100.

In addition to cost and power savings, modifying rendered content as a function of the eye focus area may allow the computing device 100 to provide an improved user experience. In some embodiments, the computing device 100 may prioritize visual characteristics within the viewer's eye focus area, thus providing better quality for areas of user interest. Additionally or alternatively, the computing device 100 may prioritize visual characteristics at an area of the display screen outside of the viewer's eye focus area in order to draw the viewer's attention to a different area of the screen. Such improved user experience may be utilized by productivity applications (e.g., prioritizing the portion of a document the viewer is working on, or providing visual cues to direct the user through a task), by entertainment applications (e.g., changing the focus point of a 3-D scene for dramatic effect), and by other applications.

The computing device 100 may be embodied as any type of computing device having a display screen and capable of performing the functions described herein. For example, the computing device 100 may be embodied as, without limitation, a computer, a desktop computer, a personal computer (PC), a tablet computer, a laptop computer, a notebook computer, a mobile computing device, a smart phone, a cellular telephone, a handset, a messaging device, a work station, a network appliance, a web appliance, a distributed computing system, a multiprocessor system, a processor-based system, a consumer electronic device, a digital television device, a set-top box, and/or any other computing device having a display screen on which content may be displayed.

In the illustrative embodiment of FIG. 1, the computing device 100 includes a processor 120, an I/O subsystem 124, a memory 126, a data storage 128, and one or more peripheral devices 130. Of course, the computing device 100 may include other or additional components, such as those commonly found in a computer (e.g., various input/output devices), in other embodiments. Additionally, in some embodiments, one or more of the illustrative components may be incorporated in, or otherwise form a portion of, another component. For example, the memory 126, or portions thereof, may be incorporated in the processor 120 in some embodiments.

The processor 120 may be embodied as any type of processor currently known or developed in the future and capable of performing the functions described herein. For example, the processor may be embodied as a single or multi-core processor(s), digital signal processor, microcontroller, or other processor or processing/controlling circuit. Similarly, the memory 126 may be embodied as any type of volatile or non-volatile memory or data storage currently known or developed in the future and capable of performing the functions described herein. In operation, the memory 126 may store various data and software used during operation of the computing device 100 such as operating systems, applications, programs, libraries, and drivers. The memory 126 is communicatively coupled to the processor 120 via the I/O subsystem 124, which may be embodied as circuitry and/or components to facilitate input/output operations with the processor 120, the memory 126, and other components of the computing device 100. For example, the I/O subsystem 124 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 124 may form a portion of a system-on-a-chip (SoC) and be incorporated, along with the processor 120, the memory 126, and other components of the computing device 100, on a single integrated circuit chip.

The data storage 128 may be embodied as any type of device or devices configured for the short-term or long-term storage of data. For example, the data storage 128 may include any one or more memory devices and circuits, memory cards, hard disk drives, solid-state drives, or other data storage devices. In some embodiments, the computing device 100 maintains a heat map 206 (see FIG. 2) stored in the data storage 128. As discussed in more detail below, the heat map 206 stores changes in viewer focus area over time. Of course, the computing device 100 may store, access, and/or maintain other data in the data storage 128 in other embodiments.

In some embodiments, the computing device 100 may also include one or more peripheral devices 130. Such peripheral devices 130 may include any number of additional input/output devices, interface devices, and/or other peripheral devices. For example, in some embodiments, the peripheral devices 130 may include a display, touch screen, graphics circuitry, keyboard, mouse, speaker system, and/or other input/output devices, interface devices, and/or peripheral devices.

In the illustrative embodiment, the computing device 100 also includes a display 132 and eye tracking sensor(s) 136. The display 132 of the computing device 100 may be embodied as any type of display capable of displaying digital information such as a liquid crystal display (LCD), a light emitting diode (LED), a plasma display, a cathode ray tube (CRT), or other type of display device. Regardless of the particular type of display, the display 132 includes a display screen 134 on which the content is displayed.

The eye tracking sensor(s) 136 may be embodied as any one or more sensors capable of determining an area on the display screen 134 of the display 132 on which the viewer's eyes are focused. For example, in some embodiments, the eye tracking sensor(s) 136 may use active infrared emitters and infrared detectors to track the viewer's eye movements over time. The eye tracking sensor(s) may capture the infrared light reflected off of various internal and external features of the viewer's eye and thereby calculate the direction of the viewer's gaze. The eye tracking sensor(s) 136 may provide precise information on the viewer's eye focus area, i.e., x- and y-coordinates on the display screen 134 corresponding to the eye focus area.

Referring now to FIG. 2, in one embodiment, the computing device 100 establishes an environment 200 during operation. The illustrative embodiment 200 includes an eye tracking module 202 and a rendering module 208. Each of the eye tracking module 202 and the rendering module 208 may be embodied as hardware, firmware, software, or a combination thereof.

The eye tracking module 202 is configured to determine an area on the display screen 134 of the display 132 on which the viewer's eyes are focused, using sensor data received from the eye tracking sensor(s) 136. In some embodiments, the eye tracking module 202 may include a change filter 204. Human eye movement is characterized by short pauses, called fixations, linked by rapid movements, called saccades. Therefore, unfiltered eye tracking sensor data may generate rapid and inconsistent changes in eye focus area. Accordingly, the change filter 204 may filter the eye tracking sensor data to remove saccades from fixations. For example, in some embodiments, the change filter 204 may be a “low-pass” filter; that is, the change filter 204 may reject changes in the viewer's focus area having a focus frequency greater than a threshold focus frequency. As a corollary, the change filter 204 may reject focus area changes having a focus duration less than a threshold focus duration.

In some embodiments, the eye tracking module 202 includes a heat map 206, which records viewer focus areas over time, allowing the eye tracking module 202 to determine areas on the display screen 134 that are often focused on by the viewer. The heat map 206 may be embodied as a two-dimensional representation of the display screen 134. Each element of the heat map 206 may record the number of times the viewer has fixated on a corresponding area of the display screen 134. In other embodiments each element of the heat map 206 may record the total cumulative time the viewer has fixated on the corresponding area of the display screen 134. Thus, the heat map 206 may provide feedback on multiple areas on the display screen 134 of interest to the viewer. The heat map 206 may record data for a limited period of time, for example, for the most recent fixed period of time, or during operation of a particular application. Data in the heat map 206 may be visualized as a color-coded two-dimensional representation overlaying the content rendered on the display screen 134. Such visualization appears similar to a false-color infrared image, lending the name “heat map.”

The rendering module 208 is configured to adjust one or more visual characteristics of rendered content as a function of the viewer's eye focus area. In some embodiments, the rendering module 208 may prioritize visual characteristics within the eye focus area. That is, the visual characteristics may be adjusted to improve visual characteristics within the eye focus area or to degrade visual characteristics outside of the eye focus area. In alternative embodiments, the rendering module 208 may prioritize visual characteristics outside of the eye focus area, for example to encourage the viewer to change the viewer's focus area. To accomplish such prioritization, the visual characteristics at the eye focus area may be degraded or the visual characteristics at a location away from the eye focus area may be improved. Some embodiments may prioritize visual characteristics both within and outside of the eye focus area, depending on the particular context. As discussed in more detail below, the visual characteristics may be embodied as any type of visual characteristic of the content that may be adjusted.

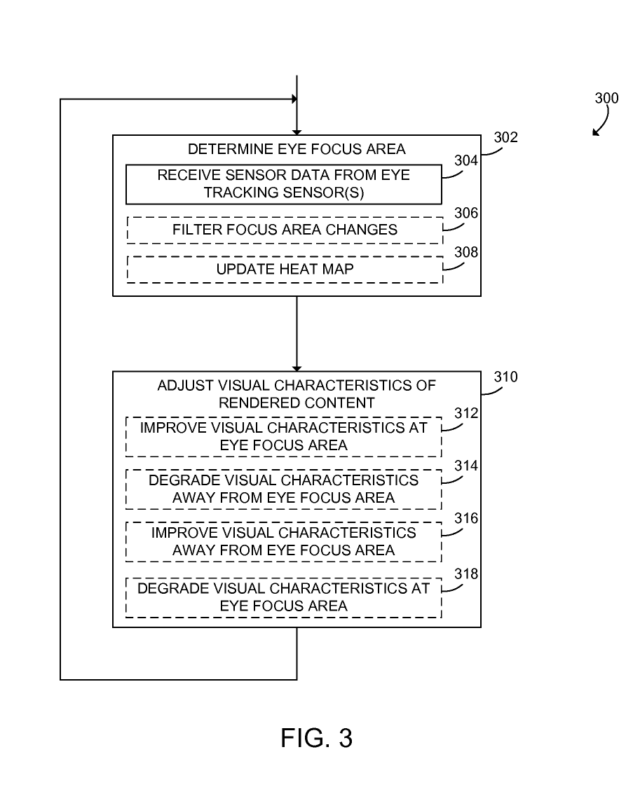

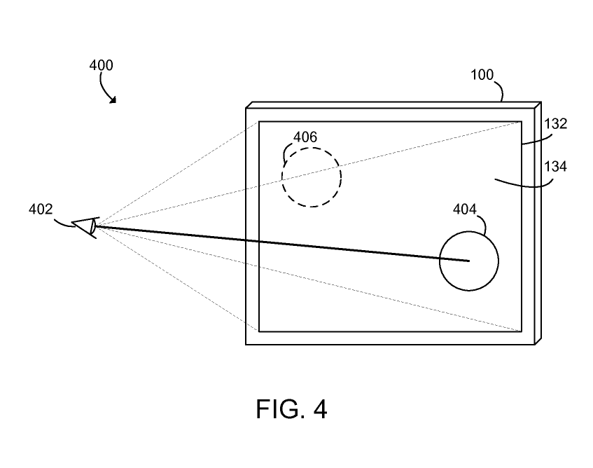

Referring now to FIG. 3, in use, the computing device 100 may execute a method 300 for modifying rendered output on a display of a computing device based on a viewer's eye focus area. The method 300 begins with block 302, in which the eye tracking module 202 determines the eye focus area. For example, referring to FIG. 4, a schematic diagram 400 illustrates a viewer 402 focused on an eye focus area 404 on the display screen 134 of the display 132 of the computing device 100. The eye focus area 404 is illustrated as circular but could be any shape enclosing an area on the display screen 134. The eye focus area may be embodied as a group of pixels or other display elements on the display screen 134, or may be embodied as a single pixel or display element on the display screen 134. Referring back to FIG. 3, in block 304, the eye tracking module 202 receives eye tracking sensor data from the eye tracking sensor(s) 136. The eye focus area may be determined directly as a function of the eye tracking sensor data. Alternatively, as discussed below, the eye focus area may be determined using one or both of the change filter 204 and the heat map 206.

In block 306, the eye tracking module 202 may filter the eye tracking sensor data using the change filter 204. As discussed above, the change filter 204 is embodied as a low-pass filter, which rejects rapid and inconsistent changes in the eye focus area. For example, in some embodiments, the change filter 204 may filter out eye focus area changes with focus duration lasting less than 200 milliseconds (200 ms). Such period corresponds with rejecting eye movement changes with focus frequency greater than 5 times per second (5 Hz). Of course, change filters having other filter properties may be used in other embodiments.

In block 308, the eye tracking module 202 may update the heat map 206 with the eye tracking sensor data. As discussed above, the heat map 206 records eye focus area changes over time. Areas representing higher “density” in the heat map 206 correspond to areas of the display screen 134 on which the viewer has focused more often, which in turn may correspond to areas on the display screen 134 of higher interest to the viewer. The eye tracking module 202 may refer to the heat map 206 to determine the eye focus area, taking into account frequently-focused areas on the display screen 134 of the display 132.

In block 310, the rendering module 208 adjusts visual characteristics of the rendered content as a function of the eye focus area determined in block 302. In some embodiments, adjusted visual characteristics may be embodied as the level of detail of rendered content. The level of detail of rendered content has many potential embodiments. For example, for three-dimensional content, the level of detail may be embodied as the number of polygons and/or the level of detail of various textures used to construct a scene. For other embodiments, the level of detail may be embodied as the number of rays traced to generate an image, as with ray-tracing rendering systems. In other embodiments, the level of detail may be embodied as the number of display elements of the display screen 134 used to render an image. For example, certain high-resolution display technologies may render groups of physical pixels (often four physical pixels) together as a single logical pixel, effectively reducing the resolution of the screen. The visual characteristics may also be embodied as visual rendering effects such as antialiasing, shaders (e.g., pixel shaders or vertex shaders), anisotropic filtering, lighting, shadowing, focusing, or blurring. Of course, the visual characteristics are not limited to three-dimensional rendered content. For example, the visual characteristics may be embodied as color saturation or display brightness. For certain display technologies, the brightness of individual display elements could be adjusted; that is, the brightness of less than the entire display screen 134 may be adjusted. The visual characteristics may also be embodied as rendering priority. For example, certain visually intensive applications render content in parts (often called “tiles”); that is, large content is split into smaller parts and the parts are rendered separately and often at different times. In some embodiments, adjusting rendering priority would control the order of rendering the various parts making up the content. For example, a graphics editing application could render the part of the image containing the eye focus area first. As another example, a graphical browser rendering content described in a markup language (e.g., HTML5) may render text or download images for the elements of the HTML 5 document containing the eye focus area first.

In some embodiments, the rendering module 208 may adjust the visual characteristics of different areas of the displayed content in different ways. For example, in block 312, the rendering module 208 may improve visual characteristics of the rendered content within the eye focus area. Improving visual characteristics within the eye focus area may improve the image quality perceived by the viewer and may use hardware resources more efficiently than improving visual characteristics of the entire content. Additionally or alternatively, in block 314, the rendering module 208 may degrade visual characteristics of rendered content outside of the eye focus area. Because the visual characteristics within the eye focus area are unchanged, the image quality perceived by the viewer may remain unchanged while rendering efficiency is increased.

The precise nature of “improving” or “degrading” a visual characteristic depends on the particular visual characteristic. For example, the polygon count may be improved by increasing the number of polygons and degraded by decreasing the number of polygons. The level of detail of textures may be improved by increasing the size, resolution, or quality of the textures and degraded by decreasing the size, resolution, or quality of the textures. Rendering effects may be improved by adding additional effects or by improving the quality of the effects. For example, shaders may be improved by utilizing additional or more computationally intensive shaders. Rendering effects may be degraded by removing effects or decreasing the quality of the effects. Color saturation or brightness may be improved by increasing the color saturation or brightness and degraded by decreasing the color saturation or brightness.

In some embodiments, the rendering module 208 may, additionally or alternatively, improve visual characteristics of the rendered content at an area on the display screen 134 outside of the eye focus area. For example, referring to FIG. 4, the schematic diagram 400 illustrates the viewer 402 focused on the eye focus area 404 on the display screen 134 of the display 132 of the computing device 100. A hashed area 406 represents an area of the display away outside of the eye focus area 404. By improving the visual characteristics within the area 406, the computing device 100 may encourage the viewer to shift the viewer's focus to the area 406. Referring back to FIG. 3, in block 318, the rendering module 316 may, additionally or alternatively, degrade visual characteristics of the rendered content within the eye focus area. Degrading the visual characteristics in locations on the display screen 134 including the eye focus area may encourage the viewer to shift the viewer's focus to another area of the display with visual characteristics that are not degraded. Particular visual characteristics may be improved or degraded as described above.

After the visual characteristics are adjusted, the method 300 loops back to block 302 in which the computing device 100 determines the eye focus area. Thus, the computing device 100 continually monitors the eye focus area and adjusts the visual characteristics appropriately.

### EXAMPLES

Illustrative examples of the devices and methods disclosed herein are provided below. An embodiment of the devices and methods may include any one or more, and any combination of, the examples described below.

Example 1 includes a computing device to modify rendered content on a display of the computing device as a function of eye focus area. The computing device includes a display having a display screen on which content can be displayed; an eye tracking sensor to generate sensor data indicative of the position of an eye of a user of the computing device; an eye tracking module to receive the sensor data from the eye tracking sensor and determine an eye focus area on the display screen as a function of the sensor data; and a rendering module to adjust a visual characteristic of the rendered content on the display as a function of the eye focus area.

Example 2 includes the subject matter of Example 1, and wherein the eye tracking module further comprises a change filter to filter the sensor data to remove saccades from fixations.

Example 3 includes the subject matter of any of Example 1 and 2, and wherein the eye tracking module is further to update a heat map with the sensor data and reference the heat map to determine the eye focus area.

Example 4 includes the subject matter of any of Examples 1-3, and wherein to adjust the visual characteristic of the rendered content comprises to improve the visual characteristic of the rendered content within the eye focus area.

Example 5 includes the subject matter of any of Examples 1-4, and wherein to adjust the visual characteristic of the rendered content comprises to degrade the visual characteristic of the rendered content located outside of the eye focus area.

Example 6 includes the subject matter of any of Examples 1-5, and wherein to adjust the visual characteristic of the rendered content comprises to improve the visual characteristic of the rendered content at an area on the display screen of the display outside of the eye focus area.

Example 7 includes the subject matter of any of Examples 1-6, and wherein to adjust the visual characteristic of the rendered content comprises to degrade the visual characteristic of the rendered content on the display screen of the display except for an area on the display screen outside of the eye focus area.

Example 8 includes the subject matter of any of Examples 1-7, and wherein to adjust the visual characteristic comprises to adjust a level of detail of the rendered content.

Example 9 includes the subject matter of any of Examples 1-8, and wherein to adjust the level of detail comprises to adjust a count of polygons used to render the rendered content.

Example 10 includes the subject matter of any of Examples 1-9, and wherein to adjust the level of detail comprises to adjust a set of textures used to render the rendered content.

Example 11 includes the subject matter of any of Examples 1-10, and wherein to adjust the level of detail comprises to adjust a number of rays traced to render the rendered content.

Example 12 includes the subject matter of any of Examples 1-11, and wherein to adjust the level of detail comprises to adjust a number of display elements used to render the rendered content.

Example 13 includes the subject matter of any of Examples 1-12, and wherein to adjust the visual characteristic comprises to adjust at least one rendering effect selected from the group consisting of: anti-aliasing, shading, anisotropic filtering, lighting, shadowing, focusing, or blurring.

Example 14 includes the subject matter of any of Examples 1-13, and wherein to adjust the visual characteristic comprises to adjust color saturation.

Example 15 includes the subject matter of any of Examples 1-14, and wherein to adjust the visual characteristic comprises to adjust brightness of the display screen.

Example 16 includes the subject matter of any of Examples 1-15, and wherein to adjust brightness of the display screen comprises to adjust brightness of an area of the display screen less than the entire display screen.

Example 17 includes the subject matter of any of Examples 1-16, and wherein to adjust the visual characteristic comprises to adjust rendering priority, wherein the rendered content comprises a plurality of parts that are rendered at different times.

Example 18 includes the subject matter of any of Examples 1-17, and wherein the plurality of parts that are rendered at different times comprises a plurality of hypertext elements represented in a hypertext markup language.

Example 19 includes a method for modifying rendered content on a display of a computing device as a function of eye focus area. The method includes receiving, on the computing device, sensor data indicative of the position of an eye of a user of the computing device from an eye tracking sensor of the computing device; determining, on the computing device, an eye focus area on a display screen of the display as a function of the sensor data; and adjusting, on the computing device, a visual characteristic of the rendered content on the display as a function of the eye focus area.

Example 20 includes the subject matter of Example 19, and wherein determining the eye focus area further comprises filtering, on the computing device, the sensor data to remove saccades from fixations.

Example 21 includes the subject matter of any of Examples 19 and 20, and wherein determining the eye focus area further comprises updating, on the computing device, a heat map with the sensor data and referencing, on the computing device, the heat map to determine the eye focus area.

Example 22 includes the subject matter of any of Examples 19-21, and wherein adjusting the visual characteristic of the rendered content comprises improving the visual characteristic of the rendered content within the eye focus area.

Example 23 includes the subject matter of any of Examples 19-22, and wherein adjusting the visual characteristic of the rendered content comprises degrading the visual characteristic of the rendered content located outside of the eye focus area.

Example 24 includes the subject matter of any of Examples 19-23, and wherein adjusting the visual characteristic of the rendered content comprises improving the visual characteristic of the rendered content at an area on the display screen of the display outside of the eye focus area.

Example 25 includes the subject matter of any of Examples 19-24, and wherein adjusting the visual characteristic of the rendered content comprises degrading the visual characteristic of the rendered content on the display screen of the display except for an area on the display screen outside of the eye focus area.

Example 26 includes the subject matter of any of Examples 19-25, and wherein adjusting the visual characteristic comprises adjusting a level of detail of the rendered content.

Example 27 includes the subject matter of any of Examples 19-26, and wherein adjusting the level of detail comprises adjusting a count of polygons used to render the rendered content.

Example 28 includes the subject matter of any of Examples 19-27, and wherein adjusting the level of detail comprises adjusting a set of textures used to render the rendered content.

Example 29 includes the subject matter of any of Examples 19-28, and wherein adjusting the level of detail comprises adjusting a number of rays traced to render the rendered content.

Example 30 includes the subject matter of any of Examples 19-29, and wherein adjusting the level of detail comprises adjusting a number of display elements used to render the rendered content.

Example 31 includes the subject matter of any of Examples 19-30, and wherein adjusting the visual characteristic comprises adjusting at least one rendering effect selected from the group consisting of: anti-aliasing, shading, anisotropic filtering, lighting, shadowing, focusing, or blurring.

Example 32 includes the subject matter of any of Examples 19-31, and wherein adjusting the visual characteristic comprises adjusting color saturation.

Example 33 includes the subject matter of any of Examples 19-32, and wherein adjusting the visual characteristic comprises adjusting brightness of the display screen.

Example 34 includes the subject matter of any of Examples 19-33, and wherein adjusting brightness of the display screen comprises adjusting brightness of an area of the display screen less than the entire display screen.

Example 35 includes the subject matter of any of Examples 19-34, and wherein adjusting the visual characteristic comprises adjusting rendering priority, wherein the rendered content comprises a plurality of parts that are rendered at different times.

Example 36 includes the subject matter of any of Examples 19-35, and wherein the adjusting rendering priority comprises adjusting rendering priority of a plurality of hypertext elements represented in a hypertext markup language.

Example 37 includes a computing device having a processor and a memory having stored therein a plurality of instructions that when executed by the processor cause the computing device to perform the method of any of claims 19-36.

Example 38 includes one or more machine readable storage media comprising a plurality of instructions stored thereon that in response to being executed result in a computing device performing the method of any of claims 19-36.

1. A computing device to modify rendered content on a display of the computing device as a function of eye focus area, the computing device comprising:
a display having a display screen on which content can be displayed;
an eye tracking sensor to generate sensor data indicative of the position of an eye of a user of the computing device;
an eye tracking module to receive the sensor data from the eye tracking sensor and determine an eye focus area on the display screen as a function of the sensor data; and
a rendering module to adjust a visual characteristic of the rendered content on the display as a function of the eye focus area.

2. The computing device of claim 1, wherein the eye tracking module further comprises a change filter to filter the sensor data to remove saccades from fixations.

3. The computing device of claim 1, wherein the eye tracking module is further to update a heat map with the sensor data and reference the heat map to determine the eye focus area.

4. The computing device of claim 1, wherein to adjust the visual characteristic of the rendered content comprises to improve the visual characteristic of the rendered content within the eye focus area.

5. The computing device of claim 1, wherein to adjust the visual characteristic of the rendered content comprises to degrade the visual characteristic of the rendered content located outside of the eye focus area.

6. The computing device of claim 1, wherein to adjust the visual characteristic of the rendered content comprises to improve the visual characteristic of the rendered content at an area on the display screen of the display outside of the eye focus area.

7. The computing device of claim 1, wherein to adjust the visual characteristic of the rendered content comprises to degrade the visual characteristic of the rendered content on the display screen of the display except for an area on the display screen outside of the eye focus area.

8. The computing device of claim 1, wherein to adjust the visual characteristic comprises at least one of: (i) to adjust a level of detail of the rendered content, (ii) to adjust a rendering effect, (iii) to adjust color saturation, and (iv) to adjust brightness of the display screen.

9. The computing device of claim 8, wherein to adjust the level of detail comprises to adjust at least on of: (i) a count of polygons used to render the rendered content, (ii) a set of textures used to render the rendered content, (iii) a number of rays traced to render the rendered content, and (iv) a number of display elements used to render the rendered content.

10. The computing device of claim 8, wherein to adjust a rendering effect comprises to adjust a rendering effect selected from the group consisting of: anti-aliasing, shading, anisotropic filtering, lighting, shadowing, focusing, or blurring.

11. The computing device of claim 8, wherein to adjust brightness of the display screen comprises to adjust brightness of an area of the display screen less than the entire display screen.

12. The computing device of claim 1, wherein to adjust the visual characteristic comprises to adjust rendering priority, wherein the rendered content comprises a plurality of parts that are rendered at different times.

13. The computing device of claim 17, wherein the plurality of parts that are rendered at different times comprises a plurality of hypertext elements represented in a hypertext markup language format selected from the group consisting of: HTML, XHTML, and HTML5.

14. The computing device of claim 1, wherein the rendering module is to adjust a visual characteristic of the rendered content using a hypertext markup language format selected from the group consisting of: HTML, XHTML, and HTML5.

15. One or more machine readable storage media comprising a plurality of instructions stored thereon that in response to being executed result in a computing device:
receiving, on the computing device, sensor data indicative of the position of an eye of a user of the computing device from an eye tracking sensor of the computing device;
determining, on the computing device, an eye focus area on a display screen of the display as a function of the sensor data; and
adjusting, on the computing device, a visual characteristic of the rendered content on the display as a function of the eye focus area.

16. The one or more machine readable storage media of claim 15, wherein adjusting the visual characteristic of the rendered content comprises at least one of: (i) improving the visual characteristic of the rendered content within the eye focus area, (ii) degrading the visual characteristic of the rendered content located outside of the eye focus area, (iii) improving the visual characteristic of the rendered content at an area on the display screen of the display outside of the eye focus area, and (iv) degrading the visual characteristic of the rendered content on the display screen of the display except for an area on the display screen outside of the eye focus area.

17. The one or more machine readable storage media of claim 15, wherein adjust the visual characteristic comprises adjusting at least one of: (i) a level of detail of the rendered content, (ii) a rendering effect, (iii) color saturation, and (iv) brightness of the display screen.

18. The one or more machine readable storage media of claim 15, wherein adjusting the visual characteristic comprises adjusting rendering priority, wherein the rendered content comprises a plurality of parts that are rendered at different times.

19. The one or more machine readable storage media of claim 15, wherein adjusting the visual characteristic of the rendered content comprises adjusting a visual characteristic of the rendered content using a hypertext markup language format selected from the group consisting of: HTML, XHTML, and HTML5.

20. A method for modifying rendered content on a display of a computing device as a function of eye focus area, the method comprising:
receiving, on the computing device, sensor data indicative of the position of an eye of a user of the computing device from an eye tracking sensor of the computing device;
determining, on the computing device, an eye focus area on a display screen of the display as a function of the sensor data; and
adjusting, on the computing device, a visual characteristic of the rendered content on the display as a function of the eye focus area.

21. The method of claim 20, wherein adjusting the visual characteristic of the rendered content comprises at least one of: (i) improving the visual characteristic of the rendered content within the eye focus area, (ii) degrading the visual characteristic of the rendered content located outside of the eye focus area, (iii) improving the visual characteristic of the rendered content at an area on the display screen of the display outside of the eye focus area, and (iv) degrading the visual characteristic of the rendered content on the display screen of the display except for an area on the display screen outside of the eye focus area.

22. The method of claim 20, wherein adjust the visual characteristic comprises adjusting at least one of: (i) a level of detail of the rendered content, (ii) a rendering effect, (iii) color saturation, and (iv) brightness of the display screen.

23. The method of claim 20, wherein adjusting the visual characteristic comprises adjusting rendering priority, wherein the rendered content comprises a plurality of parts that are rendered at different times.

24. The method of claim 20, wherein adjusting the visual characteristic of the rendered content comprises adjusting a visual characteristic of the rendered content using a hypertext markup language format selected from the group consisting of: HTML, XHTML, and HTML5.
